(19) United States
(12) Patent Application Publication
(10) Pub. No.: US 2003/0108028 A1
(43) Pub. Date: Jun. 12, 2003

(54) Method and device for evaluation of a radio signal

(75) Inventors: Christopher Brunner, Wittlich (DE); Bernhard Raaf, Munchen (DE); Alexander Seeger, Feldkirchen (DE)

Correspondence Address: STAAS & HALSEY LLP, 700 11TH STREET, NW, SUITE 500, WASHINGTON, DC, 20001, US

(73) Assignee: Seimens Aktiengesellschaft, Munich (DE)

(21) Appl. No.: 10/312,964

(22) PCT Filed: Jun. 26, 2001
(86) PCT No.: PCT/DE01/02342

(30) Foreign Application Priority Data
Jul. 4, 2000 (DE) 10032427.4

(51) Int. Cl. H04B 7/212

(52) U.S. Cl. 370/347; 370/321

(57) ABSTRACT

In order to evaluate a radio signal in a radio receiver, comprising an antenna device with several antennae elements (A₁, . . . , A_{M}), each of which delivers a received signal (U₁, . . . , U_{M}), a number N of first weighting vectors w^{(k,1)}, w^{(k,2)}, which represent a selection of the eigen vectors for the time-determined spatial covariant matrix, for a user station (MSk) are determined. The symbols contained in the user signal Iₖ, obtained by the formation of a product of the form SWU are assessed. W is the M×N matrix for the first weighting vectors, S is a selection vector with N components and U is the vector for the received signals (U₁, . . . , U_{M}). The selection vector is cyclically fixed in the working phase. A device for the evaluation of a radio signal, comprises, amongst others, a memory element (10) for the storage of N weighting vectors for each one same sender (MSk) and a beam formation network (1) with a control input of the selection vector (S).

The present invention relates to a method and to a device for evaluating a radio signal in a receiver for a radio communications system, the receiver comprising an antenna device having a number of antenna elements.

In radio communications systems, messages (voice, image information or other data) are transmitted with the aid of electromagnetic waves (radio interface) via transmission channels. The transmission takes place both in the downlink from the base station to the subscriber station and in the uplink from the subscriber station to the base station.

Signals which are transmitted by means of the electromagnetic waves are subject to, among other things, disturbances due to interference during their propagation in a propagation medium. Disturbances due to noise can arise from, among other things, noise in the input stage of the receiver. Signal components pass along different propagation paths due to refractions and reflections. The result is, on the one hand, that a signal at the receiver is often a mixture of a number of contributions which, although they originate from the same transmitted signal, can reach the receiver several times, in each case from different directions, with different delays, attenuations and phase angles. On the other hand, contributions of the received signal can interfere with themselves coherently with alternating phase relations at the receiver and can lead there to cancellation effects on a short-term time scale (fast fading).

From DE 197 12 549 A1, it is known to use smart antennas, i.e. antenna arrangements having a number of antenna elements, for increasing the transmission capacity in the uplink. These provide for a selective alignment of the antenna gain in a direction from which the uplink signal is coming.

Such antenna devices can be used in cellular mobile radio communications systems because they make it possible to allocate transmission channels, i.e. carrier frequencies, time slots, spread-spectrum codes etc. depending on the mobile radio communications system considered, to several subscriber stations in a cell which are active at the same time without disturbing interferences occurring between the subscriber stations.

From A. J. Paulraj, C. B. Papadias, “Space-time processing for wireless communications”, IEEE Signal Processing Magazine, November 1997, pp. 49-83, various methods for spatial signal separation for the uplink and the downlink are known.

From DE 198 03 188 A, a method is known in which a spatial covariance matrix for a radio link from a base station to a subscriber station is determined. In the base station, an eigenvector of the covariance matrix is calculated and used as a beam shaping vector for the connection. Transmit signals for the connection are weighted with the beam shaping vector and supplied to antenna elements for radiation. Intracell interference is not included in the beam shaping due to the use of joint detection, for example in the terminals, and a corruption of the received signal due to intracell interference is neglected.

Illustratively said, this method determines in an environment with multipath propagation, a propagation path with good transmission characteristics and spatially concentrates the transmit power of the base station on this propagation path. However, this cannot prevent interference on this transmission path being able to lead to short-term signal cancellations and thus to interruptions in the transmission.

The approaches described above only bring advantages in those environments in which directions of arrival of the radio signals are clearly discernible at the receiver and in which the delays between radio signals which have arrived at the receiver over different propagation paths are sufficiently large. In environments without these prerequisites, e.g. in the interior of buildings where delay differences are short and no unambiguous corrections of origin of radio signals can be discerned, these known methods do not provide any better results than with reception by means of a single antenna. Phase fluctuations can, therefore, lead to short-term attenuations or cancellations of the received signal (fast fading).

Another principle of the application of antenna devices having a number of antenna elements in radio communications systems is known from X. Bernstein, A. M. Haimovich, “Space-Time Optimum Combining for CDMA Communications”, Wireless Personal Communications, volume 3, 1969, pages 73 to 89, Kluwer Academic Publishers. This method is based on the fact that cancellations of the received signal due to phase fluctuations are in most cases limited to small spatial areas so that frequently not all antenna elements of an antenna device are simultaneously affected. This fact is used by estimating the transmission channels for each antenna element individually within short time intervals by superimposing the received signals received by the individual antenna elements and coming from the same transmitter in a maximum ratio combiner and evaluating the signal thus obtained. However, this method is not compatible with a spatial alignment of the transmission or receiving pattern of the antenna elements, i.e. the multiple use of channels for different mutually spatially separate subscriber stations in one cell of a radio communications system is not possible. In addition, the effectiveness of this method is greatly restricted if it is used in environments in which a direction can be allocated to the radio signals arriving at the receiver. This is because the possibility of allocating a direction of origin to the radio signals is equivalent to the existence of a phase correlation between the received signals received by the various antenna elements. This, in turn, means that when an element of the antenna device is affected by a cancellation of the received signal, a not negligible probability exists that is similar in the case of adjacent antenna elements.

The invention is based on the object of specifying a method and a device for evaluating a radio signal in a radio receiver having a number of antenna elements which, on the one hand, make it possible to align the receiving pattern of the receiver in the direction of a transmitter and which, nevertheless, is protected against signal failures due to fast fading.

This object is achieved by the method according to the invention having the features of patent claim 1 and the device having the features of patent claim 12. Further developments of the invention can be found in the subclaims.

The method according to the invention is used, in particular, in a radio communications system comprising a base station and subscriber stations. The subscriber stations are, for example, mobile stations as in a mobile radio network or fixed stations as in so-called subscriber access networks for wireless subscriber access. The base station has an antenna device (smart antenna) having a number of antenna elements. The antenna elements provide for directional reception or, respectively, directional transmission of data via the radio interface.

In the method according to the invention, it is assumed that in an environment with multipath propagation, a plurality of directions, from which the radio signal arrives at the receiver, can frequently be allocated to a radio signal coming from the same transmitter. These directions do not change when the transmitter and receiver are stationary, and when one of the two is moving, the changes caused by this movement in the received signal are small in comparison with those caused by fast fading. The receiving pattern of the receiver can be directed in the corresponding direction by weighting the received signals supplied by the individual antenna elements with the components of a suitable weighting vector. Taking into consideration a selection vector which changes rapidly in comparison with the weighting vectors allows dynamic adaptation to the fast fading on the individual propagation paths and a “switching-over” of the receiving pattern between different propagation paths or simultaneously taking into consideration the contributions from different propagation paths to the received signal of the antenna elements.

To determine the weighting vectors, a first spatial covariance matrix of the M received signals is preferably generated in the initialization phase, eigenvectors of the first covariance matrix are determined, and these are used as first weighting vectors.

In order to limit accidental influences due to fast fading during the determination of the eigenvectors, it is suitable that the first covariance matrix is averaged over a period of time which corresponds to a multiplicity of cycles of the operating phase. In this manner, corruption during the determination of the eigenvectors due to the influence of phase fluctuations is averaged out.

The first covariance matrix can be generated uniformly for the totality of the received signals received from the antenna elements. Since, however the contributions of the individual transmission paths to the received signal which are not only due to the path traveled but also due to the delay needed for this path, it is more informative, if the radio signal transmitted is a code-division multiplex radio signal, if the first covariance matrix is generated individually for each tap of the radio signal.

To reduce the processing complexity, it is suitable if not all the eigenvectors of the first covariance matrix or matrices are determined but only those which have the greatest eigenvalues because these correspond to the propagation paths having the least attenuation.

According to a first preferred embodiment of the method, a vector of so-called eigensignals is formed from the received signals of the antenna elements in the operating phase, by multiplying the vector of the received signals by a matrix W, the columns (or rows) of which are in each case the eigenvectors determined. In other words: the received signals are weighted in all eigenvectors determined. Each of the eigensignals thus obtained corresponds to the contribution of a transmission path to the received signals of the antenna elements. This means: the contributions supplied by the individual antenna elements are converted into contributions of individual transmission paths. The intermediary signal to be evaluated is then obtained by weighting the vector of eigensignals thus obtained with the selection vector. The power of the eigensignals generated here in an intermediate step can be measured and the components of the selection vector are preferably defined in each cycle in dependence on the power of these eigensignals. This embodiment is simple and can be inexpensively implemented since existing receivers for smart antennas can be used for processing the eigensignals further up to the symbol estimation.

An alternative second embodiment of the method provides that a second spatial covariance matrix is generated in each cycle in the operating phase, that the eigenvalues of the eigenvectors determined are calculated for the second spatial covariance matrix, and that each component of the selection vector is defined by means of the eigenvalue of the eigenvector corresponding to this component. This method can be implemented with relatively low circuit expenditure since it is not necessary to generate a number of eigensignals and the generation of covariance matrices of the received signals is required in any case in order to determine the eigenvectors.

In both embodiments of the method, the components of the selection vector can be defined in accordance with a maximum ratio combining method. As an alternative, all components of the selection vector can be defined to be equal to 0 with the exception of those which correspond to a predetermined number of in each case best transmission paths, i.e. the strongest eigensignals in the case of the first embodiment and, respectively, the greatest eigenvalues in the case of the second embodiment. In particular, the predetermined number can be 1.

The transmitter suitably periodically radiates a training sequence which is known to the receiver so that the receiver can determine the first weighting vectors by means of the training sequences received. In the case of the second embodiment of the method, in particular, this allows a second covariance matrix to be generated for each training sequence transmitted and thus the selection vector with each training sequence to be updated. When a number of transmitters can communicate with the receiver at the same time, they suitably use orthogonal training sequences.

A device for evaluating a radio signal for a radio receiver exhibiting an antenna device having M antenna elements comprises a beam shaping network with M inputs for received signals supplied by the antenna elements and an output for an intermediary signal obtained by weighting the received signals with weighting vectors allocated to a transmitter, and a signal processing unit for estimating symbols contained in the intermediary signal. It is characterized by a storage element for storing N weighting vectors in each case allocated to the same transmitter, and the beam shaping network has a control input for a selection vector, the components of which define the contribution of each individual weighting vector to the intermediary signal.

The weighting vectors are preferably eigenvectors of a first covariance matrix generated by means of the M received signals. According to a first preferred embodiment of the device, the beam shaping network comprises two stages, the first stage comprising N branches for weighting the received signals with in each case one of the N weighting vectors and the second stage weighting the eigensignals supplied by the N branches with the selection vector. Such a device can be implemented in a particularly simple manner since the second stage of the beam shaping network already exists in conventional devices for evaluating radio signals of the type described in Bernstein and Haimovich, op. cit. but provided there for evaluating individual antenna element signals and not for evaluating eigensignals. The first embodiment of the invention essentially differs from such a conventional device by the addition of the first stage of the beam shaping network and the type of generation of the selection vector.

According to a second embodiment, the beam shaping network comprises a computing unit for forming the product of beam shaping vectors with the above-mentioned matrix W⁽ of the eigenvectors, the product obtained being used as weighting vectors in the beam shaping network. In this embodiment, the beam shaping network is of particularly simple construction since it only needs to have one stage.

In the text which follows, exemplary embodiments are explained in greater detail with reference to the drawing, in which:

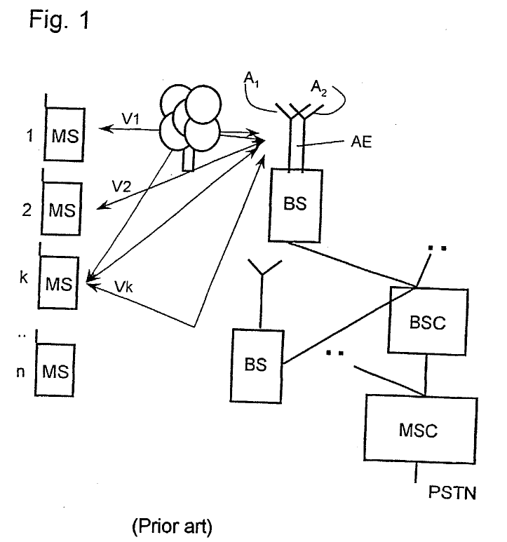

FIG. 1 shows a block diagram of a mobile radio network;

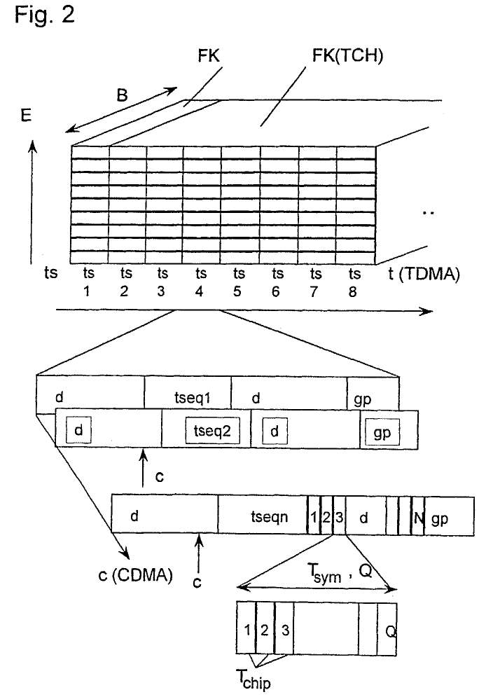

FIG. 2 shows a diagrammatic representation of the frame structure of the code-division multiple access (CDMA) radio transmission;

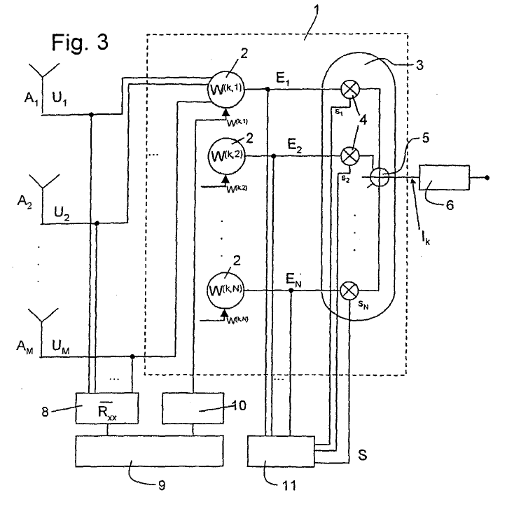

FIG. 3 shows a block diagram of a base station of a radio communications system with a device for evaluating a radio signal according to a first embodiment of the invention;

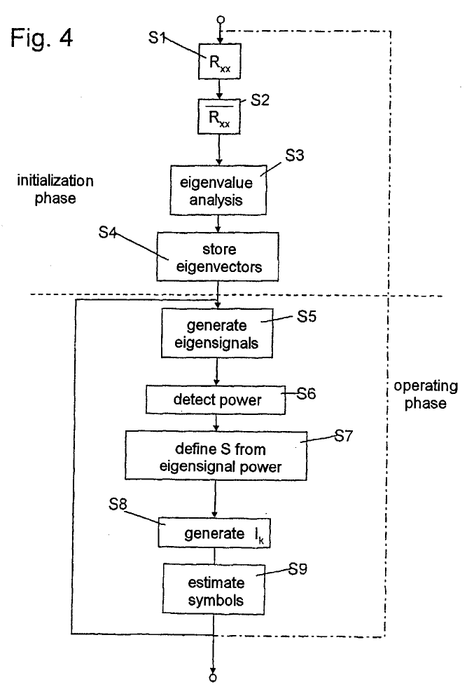

FIG. 4 shows a flowchart of the method carried out by the device;

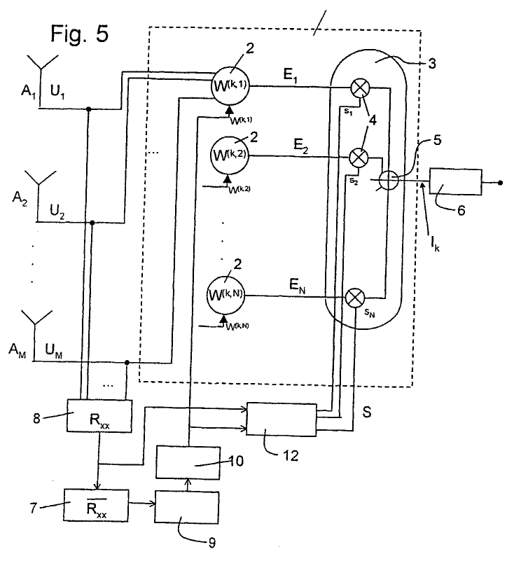

FIG. 5 shows a block diagram of a base station of a radio communications system comprising a device for evaluating a radio signal according to a second embodiment of the invention;

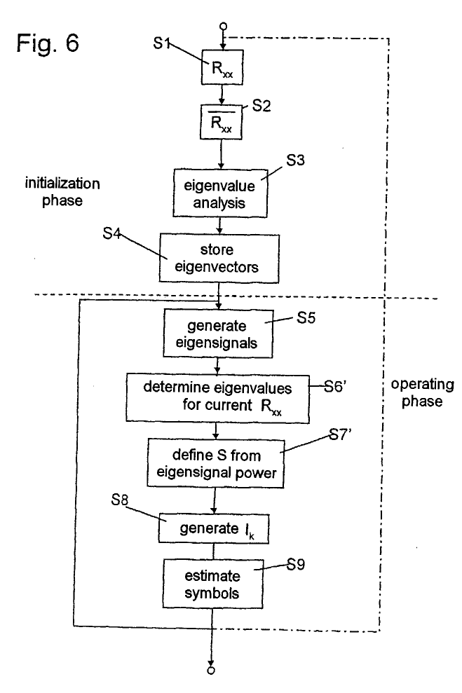

FIG. 6 shows a flowchart of the method carried out by the device;

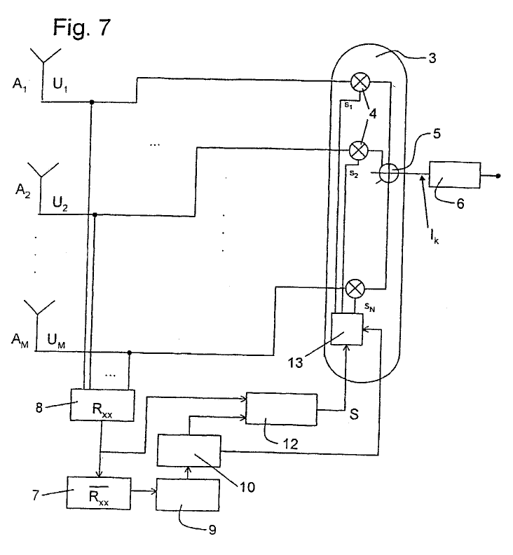

FIG. 7 shows a block diagram of a base station of a radio communications system comprising a device for evaluating a radio signal according to a third embodiment of the invention; and

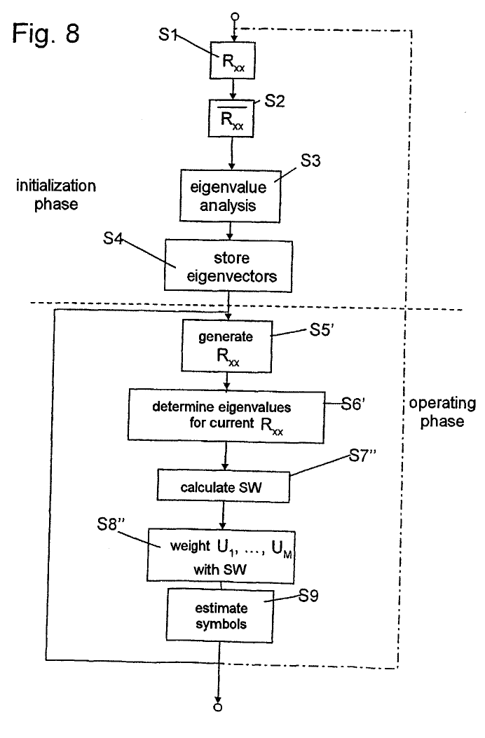

FIG. 8 shows a flowchart of the method carried out by the device.

FIG. 1 shows the structure of a radio communications system in which the method according to the invention and, respectively, the device according to the invention can be used. It consists of a multiplicity of mobile switching centers MSC, which are networked together or, respectively, provide access to a fixed network PSTN. Furthermore, these mobile switching centers MSC are connected to in each case at least one base station controller BSC. Each base station controller BSC, in turn, provides for a connection to at least one base station BS. One such base station BS can set up a communication link to subscriber stations MS via a radio interface. For this purpose, at least some of the base stations BS are equipped with antenna devices AE which have a number of antenna elements (A₁-A_{M})

In FIG. 1, connections V1, V2, Vk for transmitting user information and signaling information between subscriber stations MS1, MS2, MSk, MSn and a base station BS are illustratively shown. The connection between the base station BS and the subscriber station MSk, considered as representative of all subscribers stations in the text which follows, comprises a number of propagation paths, in each case shown by arrows.

An operations and maintenance center OMC implements control and maintenance functions for the mobile radio network or, respectively, parts thereof.

The functions of this structure can be adapted for other radio communications systems in which the invention can be used, particularly for subscriber access networks with wireless subscriber access.

FIG. 2 shows the frame structure of the radio transmission. According to a TDMA component, a broadband frequency range, for example of bandwidth B=1.2 MHz is divided into a number of timeslots ts, for example 8 timeslots ts1 to ts8. Each timeslot ts within the frequency range B forms a frequency channel FK. Within the frequency channels TCH which are only provided for the transmission of user data, information from a number of connections is transmitted in radio blocks.

These radio bursts for the transmission of user data consist of sections with data d in which sections with training sequences tseq1 to tseqn known at the receiving end are embedded. The data d are connection items individually spread with a fine structure, a subscriber code c so that, for example, n connections can be separated by this CDMA component at the receiving end.

The spreading of individual symbols of the data d has the effect that Q chips of duration T_{chip} are transmitted within the symbol period T_{sym}. The Q chips form the connection as an individual subscriber code c. Furthermore, a guard period gp for compensation for different signal delays of the connections is provided within the timeslot ts.

Within a broadband frequency range B, the successive timeslots ts are structured in accordance with a frame structure. Thus, eight timeslots ts are combined to form one frame and, for example, one timeslot ts4 of the frame forms a frequency channel for signaling FK or a frequency channel TCH for transmitting user data, the latter being repeatedly used by one group of connections.

FIG. 3 shows highly diagrammatically a block diagram of a base station of a W-CDMA radio communications system which is equipped with a device according to the invention for evaluating the uplink radio signal received by the subscriber station MSk and possibly the uplink radio signals from other subscriber stations. The base station comprises an antenna device with M antenna elements A₁, A₂, . . . , A_{M} which in each case deliver a received signal U₁ . . . U_{M}. A beam shaping network 1 comprises a multiplicity of vector multipliers 2 each of which receives the M received signals U₁ . . . U_{M} and forms the scalar product of this vector of the received signals with a weighting vector w^{(k,1)}, . . . , w^{(k,N)}.

In the text which follows, these weighting vectors will be called eigenvectors. The number N of eigenvectors or of the multipliers 2, respectively, is as large as or smaller than the number M of antenna elements.

The output signals E₁, . . . E_{N} supplied by the vector multipliers 2 are called eigensignals of the subscriber station MSk.

The vector multipliers 2 form a first stage of the beam shaping network 1; a second stage is formed by a vector multiplier 3, the inner configuration of which is also shown as representative of the configuration of the vector multipliers 2 in the figure. It has N inputs for the N eigensignals E₁, . . . E_{N} and corresponding inputs for N components of a selection vector S. Scalar multipliers 4 multiply each eigensignal by the associated component sₙ of the selection vector S. The products obtained are added by an adder 5 to form a single so-called intermediary signal Iₖ which is supplied to an estimating circuit 6 for estimating the symbols contained in the received signal. The configuration of the estimating circuit 6 is known per se and is not part of the invention which is why it will not be described in further detail here.

A signal processor 8 is also connected to the received signals U₁, . . . U_{M} and generates covariance matrices Rₓₓ of these received signals, e.g. by evaluating the training sequences cyclically transmitted by the subscriber station MSk, that is to say in each timeslot allocated to it, which sequences are known to the signal processor 8. The covariance matrices thus obtained are averaged by the signal processor 8 over a large number of cycles. The average may have an extent of a period of some seconds up to minutes.

The averaged covariance matrix \overline{Rₓₓ}, here also called the first covariance matrix, is transferred to a first computing unit 9 which performs a determination of the eigenvectors of the averaged covariance matrix \overline{Rₓₓ}. These propagation paths with different directions of arrival at the base station BS can be allocated to the uplink signal arriving at the antenna device of the base station, an eigenvector corresponds to each of these propagation paths. The averaged covariance matrix is a matrix with M rows and columns and can, therefore, have a maximum of M eigenvectors, some of which, however, can be trivial or can correspond to transmission paths which do not provide a significant contribution to the received signal. If, in particular, the number of antenna elements M is greater than 3, it is not necessary for all eigenvectors of the covariance matrix to be determined to carry out the invention; the number N of eigenvectors determined by the first computing unit 9 can be less than M.

If N is defined to be smaller than M, the first computing unit 9 determines the N eigenvectors w^{(k,1)}, . . . , w^{(k,N)} of the averaged covariance matrix \overline{Rₓₓ} which have the eigenvalues with the greatest amount among all of their eigenvectors.

A storage element 10 is used for storing these eigenvectors w^{(k,1)}, . . . , w^{(k,N)}. It is connected to the vector multipliers 2 in order to supply each of these with the eigenvector allocated to it.

The storage element 10 is shown as a uniform component in the figure but it can also consist of a plurality of registers, each of which accommodates one eigenvector and is connected to the corresponding vector multiplier 2 to form one circuit unit.

The eigensignals E₁, . . . , E_{N} generated by the vector multipliers 2 in each case correspond to the contributions provided by a single transmission path to the total uplink radio signal received by the antenna device AE. The power of these individual contributions can vary greatly due to phase fluctuations of the individual transmission paths within short periods of time of the order of magnitude of the time interval between successive timeslots of the subscriber station MSk and there can be signal cancellation on individual transmission paths. Since, however, the various transmission paths are independent of one another, the probability of signal cancellation on the various transmission paths is uncorrelated. The probability of all N eigensignals disappearing simultaneously and there being an interruption of the reception is, therefore, less than in the case of the received signals of N antenna elements since in the latter, the probabilities of failure are correlated due to the close spatial neighborhood of the antenna elements given in most cases.

A second stage of the beam shaping network combines the N eigensignals to form an intermediary signal Iₖ. This second stage comprises a second signal processor 11 which is connected to the outputs of the vector multiplier 2 in order to detect the powers of the eigensignals and to generate a selection vector S for driving the vector multiplier 3. According to a simple embodiment, the second signal processor 11 generates a selection vector S with only one nondisappearing component which is supplied to the scalar multiplier 4 which receives the strongest eigensignal. According to a preferred variant, the second signal processor 11 applies a maximum ratio combining method, i.e. it selects the coefficients s₁, . . . , s_{N} of the selection vector S in dependence on the powers of the eigensignals E₁, . . . , E_{N}, in such a manner that the intermediary signal Iₖ is obtained with the optimum signal/noise ratio by adding the eigensignals E₁, . . . , E_{N} weighted with the components of the selection vector S.

FIG. 4 illustrates the method carried out by the device of FIG. 3 by means of a flowchart. In step S1, a current covariance matrix Rₓₓ is generated by means of the training sequence transmitted by the subscriber station MSk in a timeslot. This current covariance matrix Rₓₓ is used for forming an averaged covariance matrix \overline{Rₓₓ} in step S2. The averaging can be done by all current covariance matrices Rₓₓ being added together over a given period of time or a given number of cycles or timeslots of the subscriber station, and the sum obtained being divided by the number of covariance matrices added. By comparison, a sliding averaging is more advantageous, however, since it does not mandatorily require the detection of a large number of current covariance matrices Rₓₓ before an averaged covariance matrix is available for the first time and because in it the most recent current covariance matrices, i.e. those covariance matrices Rₓₓ which presumably reproduce the most important directions of the individual propagation paths in the case of a moving subscriber station, are in each case taken into consideration most strongly.

The sliding averaging is done in accordance with the following formula

(\overline{Rₓₓ})=ρ(\overline{Rₓₓ})ᵢ₋₁+(1−ρ)Rₓₓᵢ,

where (\overline{Rₓₓ})ᵢ is in each case the i-th averaged covariance matrix, (\overline{Rₓₓ})ᵢ is the i-th current covariance matrix and ρ is a measure of the time constant of the averaging with a value of between 0 and 1.

In step S3, an eigenvector analysis of the averaged covariance matrix \overline{Rₓₓ} is performed. After storage of the eigenvectors obtained (step S4), the initialization phase of the method is concluded.

If no averaged covariance matrix \overline{Rₓₓ} is yet available at the beginning of a transmission link between subscriber station MSk and base station BS, at which an eigenvalue analysis could be performed, data must still be received already. In this early phase of the transmission link, predetermined first weighting vectors are used instead of determined eigenvectors for weighting the uplink signal. The number of these predetermined first weighting vectors is no greater than that of the number of antenna elements of the base station; it can be selected to be equal to the number of eigenvectors determined later.

The predetermined first weighting vectors form an orthogonal, preferably an orthonormal system; in particular, it can be a set of vectors of the form (1,0, 0, . . . ) (0,1, 0, . . . ), (0,0, 1,0, . . . ). Such a choice of predetermined weighting vectors means that each predetermined weighting vector corresponds to the use of a single antenna element for receiving the uplink signal. In this manner, the base station can attempt to optimize the reception of the uplink signal by switching the reception between different antenna elements even before an averaged covariance matrix or, respectively, eigenvectors determined from this are present for the first time.

As an alternative, the number of current covariance matrices which are included in the calculation of an averaged covariance matrix can be selected to be smaller at the beginning of the transmission than in the later permanent operation in order to be provided with an average covariance matrix as rapidly as possible even if it does not yet permit very reliable information about the eigenvectors as an average covariance matrix which is based on more extensive statistics. In the extreme case, the current covariance matrix obtained by means of the first timeslot examined can be used as average covariance matrix and its information content can be continuously improved by the sliding averaging described above.

In the operating phase of the method, the eigensignals E₁, . . . , E_{N} are generated in step S5 by means of the eigenvectors W^{(k,1)}, . . . , w^{k,N} obtained in step S3. Generation of these eigensignals corresponds to the matrix multiplication

E=WU,

where

$$E = ( \begin{matrix}{E}_{1} \\ {E}_{2} \\ ⋮ \\ {E}_{N}\end{matrix} ) , W = ( \begin{matrix}{w}_{1}^{( k , 1 )} & {w}_{2}^{( k , 1 )} & ⋯ & {w}_{M}^{( k , 1 )} \\ {w}_{1}^{( k , 2 )} & {w}_{2}^{( k , 2 )} & & {w}_{M}^{( k , 2 )} \\ ⋮ & & ⋱ & ⋮ \\ {w}_{1}^{( k , N )} & {w}_{2}^{( k , N )} & ⋯ & {w}_{M}^{( k , N )}\end{matrix} ) , U = ( \begin{matrix}{U}_{1} \\ {U}_{2} \\ ⋮ \\ {U}_{M}\end{matrix} )$$

represent the vector of the eigensignals, the matrix of the eigenvectors and the vector of the received signals, respectively.

In step S6, the power of the eigensignals E₁, . . . , E_{N} is detected by means of which the selection vector

S=(s₁ s₂ . . . s_{N})

is defined in step S7. Thus, generation of the intermediary signal Iₖ in step S8 lastly corresponds to the formation of the product

Iₖ=SWU

where the fast updating of the selection vector S in dependence on the strengths of the eigensignals E₁, . . . , E_{N} allows rapid adaptation to the fast fading of the individual transmission paths.

FIG. 5 shows a second embodiment of the device according to the invention. Essentially, it differs from the device of FIG. 3 in that the first signal processor 8 in each case generates current covariance matrices Rₓₓ for each training sequence received by the subscriber station MSk and, on the one hand, outputs it to an averaging circuit 7 for generating the average covariance matrix \overline{Rₓₓ} and, on the other hand, to a second computing unit 12. This second computing unit 12 also receives the matrix W of the eigenvectors, determined by the first computer unit 9, of the average covariance matrix \overline{Rₓₓ} from the storage element 10 and calculates for each of these eigenvectors E₁ . . . , E_{N} its eigenvalue with the current covariance matrix Rₓₓ. This eigenvalue, like the power of the eigensignal E₁ is a measure of the quality of the propagation path allocated to the eigenvector or eigensignal, which is used by the second computing unit 12 in order to generate a selection vector S having the characteristics already described with respect to FIGS. 3 and 4. Using this selection vector S, the vector multiplier 3 combines the eigensignals E₁, . . . , E_{N} to form the intermediary signal Iₖ, the symbols of which are estimated in the estimating circuit 6.

The method carried out by this device is shown as a flowchart in FIG. 6; it differs from the method of FIG. 4 in the step S6 in which the eigenvalues of the eigenvectors are determined for the current covariance matrix Rₓₓ and the step 7 of defining the selection vector S by means of the eigenvalues.

FIG. 7 shows a third embodiment of the device according to the invention. The vector multipliers 2 have been omitted here and, instead, the received signals U₁, . . . , U_{M} are directly supplied to M scalar multipliers 4 of the vector multiplier 3. The first signal processor 8, the averaging circuit 7, the storage element 10 and the first computing units 9, 12 do not differ from those of the embodiment of FIG. 5. The set of eigenvalues determined by the second computing unit 12 is supplied as selection vector S to a selection unit 13 which, at the same time, receives the matrix W of eigenvalues from the storage element 10 and performs a matrix multiplication

$$( \begin{matrix}{S}_{1} & {S}_{2} & ⋯ & {S}_{N} )\end{matrix} ( \begin{matrix}{w}_{1}^{( k , 1 )} & {w}_{2}^{( k , 1 )} & ⋯ & {w}_{M}^{( k , 1 )} \\ {w}_{1}^{( k , 2 )} & {w}_{2}^{( k , 2 )} & & {w}_{M}^{( k , 2 )} \\ ⋮ & & & ⋮ \\ {w}_{1}^{( k , N )} & {w}_{2}^{( k , N )} & ⋯ & {w}_{M}^{( k , N )}\end{matrix} ) .$$

The intermediary signal Ik obtained at the output of the vector multiplier 3 is the same as in the case of the embodiment of FIG. 7 but the circuit complexity is considerably simplified due to the omission of the vector multiplier 2. Although a matrix multiplication takes place in the second computing unit 12, instead, the associated processing effort is much less since this matrix multiplication only needs to be performed once in each cycle of the operating phase whereas the vector multipliers 2, 3 process a multiplicity of samples in each cycle and, therefore, must have a much higher processing speed.

The operation of the embodiment of FIG. 7 is shown in the flowchart of FIG. 8. Steps S1 to S6′ are the same as in the method of FIG. 6. In the modified step S7″, the product of the selection vector S by the matrix W of the eigenvectors is calculated and in step S8″ the received signals U₁, . . . , U_{M} are weighted with the vector thus obtained. In step S9, the symbols are again estimated in the same manner as in the other embodiments.

Naturally, the components of the selection vector do not need to be identical with the set of eigenvalues for the current covariance matrix Rₓₓ in this exemplary embodiment, too; the components of the selection vector S can be calculated in any suitable manner by means of the eigenvalues and, in particular, all components can be set to be equal to 0 with the exception of those corresponding to a given number of in each case greatest eigenvalues.

A further development of the devices and methods described above is based on the finding that the uplink signal received by the antenna device of the base station is composed of a multiplicity of contributions which differ not only in their direction of origin or, respectively, their relative phase angle at the individual antenna elements and their attenuation but also in their propagation times from the subscriber station MSk to the base station BS. The propagation times of the individual contributions or, respectively, their relative delays can be determined in a manner known per se with the aid of a rake searcher and from the uplink radio signal, a number of received signals can be generated for each individual antenna element which are called taps in a CDMA radio communications system and differ from one another in that for each tap, a different time offset between the uplink radio signal and the spread-spectrum and scrambling code is in each case used as a basis in accordance with a measured delay for despreading and descrambling the uplink radio signal. According to the further development, the current covariance matrices Rₓₓ and, correspondingly, also the average covariance matrix \overline{Rₓₓ} are generated individually for each tap. This allows more than M propagation paths to be distinguished, and to be taken into consideration during the evaluation, which differ in their respective signal delay, with an antenna device comprising M antenna elements. Thus, a much more detailed and accurate evaluation of the uplink radio signal is possible than if only a single covariance matrix is generated.

The number N of eigenvectors allocated to the subscriber station MSk is not necessarily predetermined. In the case of covariance matrices Rₓₓ, \overline{Rₓₓ} being generated individually for each tap, the total number of eigenvectors taken into consideration for a subscriber station can be predetermined but the number of eigenvectors taken into consideration for each individual covariance matrix can vary. For this purpose, the totality of eigenvectors and eigenvalues is first calculated for all averaged covariance matrices of the subscriber station and from the totality of eigenvectors, which can belong to different taps, those having the greatest eigenvalue are determined and stored in the storage element 10. It may occur that the eigenvectors of those taps which only deliver a small contribution to the uplink signal are completely ignored.

It is also possible to dynamically vary the total number of eigenvectors allocated to a subscriber station in dependence on the respective transmission situation. Thus, a reduction in the number of eigenvectors to up to N=1 can be supportable in the case of a direct transmission path, particularly if the subscriber station is not moving or only moving slowly, in which case the processing capacities becoming available as a result (or vector multipliers 2 in the case of devices from FIGS. 3 and 5) can be allocated to other subscriber stations with poorer transmission conditions.

1. A method for evaluating a radio signal in a radio receiver which comprises an antenna device (AE) having a number of antenna elements (A₁ to A_{M}) which in each case deliver a received signal (U₁, . . . , U_{M}), with the following steps:
a) in an initialization phase, determining a plurality N of first weighting vectors (w^{(k,1)}, w^{(k,2)}, . . . , w^{(k,N)}) with M components for a subscriber station (MSk), and
b) in an operating phase, estimating symbols contained in an intermediary signal (Iₖ) which can be obtained by forming a product of the form
Iₖ=SWU
where W is the M×N matrix of the first weighting vectors (w^{(k,1)}, w^{(k,2)}, . . . , w^{(k,N)}), S is a selection vector with N components and U is the vector of the received signals (U₁, . . . . , U_{M}), the selection vector S being cyclically redefined in the operating phase.

2. The method as claimed in claim 1, characterized in that in the initialization phase, a first spatial covariance matrix (\overline{Rₓₓ}) of the M received signals is generated, in that eigenvectors of the first covariance (\overline{Rₓₓ}) are determined and in that the eigenvectors determined are the first weighting vectors.

3. The method as claimed in claim 2, characterized in that the first covariance matrix (\overline{Rₓₓ}) is averaged over a period corresponding to a multiplicity of cycles of the operating phase.

4. The method as claimed in claim 2 or 3, characterized in that the first covariance matrix (\overline{Rₓₓ}) is generated individually for each tap of the radio signal.

5. The method as claimed in claim 2, 3 or 4, characterized in that of the totality of eigenvectors of the first covariance matrix or matrices (\overline{Rₓₓ}), eigenvectors determined are those which have the largest eigenvalues.

6. The method as claimed in one of the preceding claims, characterized in that, in the operating phase, a vector E of eigensignals (E₁, . . . , E_{N}) is formed in accordance with the formula
E=WU
and in that the components of the selection vector (S) are defined in dependence on the power of the eigensignals (E₁, . . . , E_{N}) in each cycle.

7. The method as claimed in one of claims 2 to 5, characterized in that, in the operating phase a second spatial covariance matrix (Rₓₓ) is generated in each cycle, in that the eigenvalues of the first eigenvectors are calculated for the second spatial covariance matrix (Rₓₓ), and in that each component of the selection vector (S) is defined by means of the eigenvalue of the eigenvector corresponding to this component.

8. The method as claimed in claim 6 or 7, characterized in that components of the selection vector (S) are defined in accordance with a maximum ratio combining method.

9. The method as claimed in claim 6 or 7, characterized in that, apart from a predetermined number, all components of the selection vector (S) are defined to be equal to 0.

10. The method as claimed in one of the preceding claims, characterized in that the transmitter (MSk) periodically radiates a training sequence which is known to the receiver (BS), and in that the first weighting vectors are determined by means of the training sequences received.

11. The method as claimed in claim 10 and claim 7, characterized in that the second covariance matrix (Rₓₓ) is generated for each training sequence transmitted.

12. The method as claimed in one of the preceding claims, characterized in that before the determination of the first weighting vectors (w^{(k,1)}, w^{(k,2)}, . . . , w^{(k,N)}) is concluded, the radio signal is evaluated by estimating symbols contained in an intermediary signal (Iₖ) which can be obtained by forming a product of the form
Iₖ=SW′U,
where W′ is an M×N matrix of predefined weighting vectors (w′^{(k,1)}, w′^{(k,2)}, . . . , w′^{(k,N)}.

13. The method as claimed in claim 18, characterized in that the predefined weighting vectors (w′^{(k,1)}, w′^{(k,2)}, . . . , w′^{(k,N)}) in each case have exactly one nondisappearing component.

14. A device for evaluating a radio signal for a radio receiver exhibiting an antenna device (AE) with M antenna elements (A₁, . . . , A_{M}), the device exhibiting a beam shaping network with M inputs for received signals (U₁ . . . , U_{M}) delivered by the antenna elements (A₁, . . . , A_{M}), and an output for an intermediary signal (Iₖ) obtained by weighting the received signals with the weighting vectors (w^{(k,1)}, w^{(k,2)}, . . . , w^{(k,N)}) allocated to a transmitter (MSk) and a signal processing unit (6) for estimating symbols contained in the intermediary signal (Iₖ), characterized in that it comprises a storage element (10) for storing N weighting vectors in each case allocated to the same transmitter (MSk), and in that the beam shaping network (1) exhibits a control input for a selection vector (S), the components of which define the contribution of each individual weighting vector (w^{(k,1)}, w^{(k,2)}, . . . , w^{(k,N)}) to the intermediary signal (Iₖ).

15. The device as claimed in claim 14, characterized in that the weighting vectors (w^{(k,1)}, w^{(k,2)}, . . . , w^{(k,N)}) are eigenvectors of a first covariance matrix (\overline{Rₓₓ}) generated by means of the M received signals (U₁ . . . , U_{M}).

16. The device as claimed in claim 14, characterized in that the beam shaping network comprises two stages, the first stage comprising N branches for weighting the received signals with in each case one of the N weighting vectors (w^{(k,1)}, w^{(k,2)}, . . . , w^{(k,N)}) and the second stage weights the output signals (E₁ . . . , E_{N}) supplied by the N branches with the selection vector (S).

17. The device as claimed in claim 14, characterized in that the second stage is a maximum ratio combiner.

18. The device as claimed in claim 14, characterized in that the beam shaping network is a computing unit for forming the product S W, W being the M×N matrix of the first weighting vectors (w^{(k,1)}, w^{(k,2)}, . . . ,) and S being the selection vector (S) with N components.

19. The device as claimed in one of claims 14 to 18, characterized in that it is part of a base station (BS) of a mobile radio communications system.
